(19) United States
(12) Patent Application Publication
(10) Pub. No.: US 2024/0011788 A1
(43) Pub. Date: Jan. 11, 2024

(54) ANIMATED ROUTE PREVIEW FACILITATED BY AUTONOMOUS VEHICLES

(71) Applicant: GM Cruise Holdings LLC, San Francisco, CA (US)

(72) Inventors: Brent Valle, Livermore, CA (US); Kelan Fitzgerald Stoy, Albany, CA (US)

(73) Assignee: GM Cruise Holdings LLC, San Francisco, CA (US)

(21) Appl. No.: 17/862,048

(22) Filed: Jul. 11, 2022

(51) Int. Cl. G01C 21/36

(52) U.S. Cl. CPC G01C 21/3676; G01C 21/3694

(57) ABSTRACT

A router preview platform can provide animated route previews to users. The route preview platform may generate an animation in response to a request for animated route preview. The animation provides a preview of a navigation route. The navigation route may be generated based on information indicated in the request, such as locations, user preferences, etc. The animation may be generated based on sensor data captured by AVs. The animation may include a graphical representation of a real-world object that has been detected by a sensor of an AV during an operation of the AV in an environment surrounding the real-world object. The AV's operation in the environment may be conducted in accordance with an instruction from the router preview platform. The graphical representation is generated based on sensor data from the AV. The graphical representation may be generated further based on sensor data from multiple AVs.

### TECHNICAL FIELD OF THE DISCLOSURE

The present disclosure relates generally to autonomous vehicles (AVs) and, more specifically, to automated route preview facilitated by AVs.

### BACKGROUND

An AV is a vehicle that is capable of sensing and navigating its environment with little or no user input. An AV may sense its environment using sensing devices such as Radio Detection and Ranging (RADAR), Light Detection and Ranging (LIDAR), image sensors, cameras, and the like. An AV system may also use information from a global positioning system (GPS), navigation systems, vehicle-to-vehicle communication, vehicle-to-infrastructure technology, and/or drive-by-wire systems to navigate the vehicle. As used herein, the phrase “AV” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide services to users;

FIG. 2 is a block diagram showing a fleet management system, according to some embodiments of the present disclosure;

FIG. 3 is a block diagram showing a route preview module, according to some embodiments of the present disclosure;

FIG. 4 is a block diagram showing a sensor suite, according to some embodiments of the present disclosure;

FIG. 5 is a block diagram showing an onboard computer, according to some embodiments of the present disclosure;

FIG. 6 illustrates an example environment in which AVs operate and capture sensor data, according to some embodiments of the present disclosure;

FIG. 7 illustrates an example user interface presenting an animation that previews a route including the environment in FIG. 6, according to some embodiments of the present disclosure; and

FIG. 8 is a flowchart showing a method of providing a route preview animation, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Many people would like to preview travel routes before they make their travel plans. For example, a person who considers whether to request a ride provided by an AV may want to preview a navigation route of the AV to determine whether to request the ride or not. The person may also be interested in sharing the travel plan with another person, and the preview can be used to provide information of the travel plan to the other person. As another example, a person who wants to bike in an urban area can benefit from a preview of a biking route in the urban area, as the preview can help the person to evaluate the biking route, e.g., as safety of biking on the biking route, views along the biking route, recent construction that could impact the comfort of the biking route, and so on. Currently available route preview services are limited to static images of street views. Such street views are often out of date, as the images were usually taken a long time ago. Due to the lack of recency, the images could show conditions that are not present anymore and therefore, provide misleading information to users. Also, images of street views are typically taken by cameras attached to a small number of fleets of specially-equipped vehicles driving around on the streets. It can be expensive and time consuming to operate such vehicles. As a result, route preview services are not available for many areas. Even if route preview service is available for an area, the number of images for route preview is limited. Therefore, improved technology for route preview is needed.

Embodiments of the present disclosure provides a route preview platform that can provide an animated route preview based on sensor data captured by AVs. AVs can travel in various real-world scenes and collect sensor data capturing the real-world scenes. AVs can also perceive the real-world scenes through sensors. For instance, AVs can identify objects in the real-world scenes. Sensor data and perceptions of AVs are usually used for controlling or testing operations of AVs. However, AV sensor data and perceptions also include valuable information of the real-world scenes, e.g., information for identifying scenes that can be detected by AV sensors, such as a scene that does not have many visual obstructions. The route preview platform can use sensor data and/or perceptions of AVs to generate animations that illustrate navigation routes in real-world scenes. Such animations can provide previews of the navigation routes to users who consider whether to travel along the navigation routes.

The route preview platform allows users to submit requests for animated route preview. In some embodiments, the route preview platform takes a request for ride service as a request for an animated preview of at least part of the route of the ride service. In response to a request for animated route preview, the route preview platform may determine one or more navigation routes based on the request. The route preview platform can determine a navigation route further based on information from AVs. For instance, the route preview platform may detect a condition that can interfere with traveling through an area based on sensor data or perceptions of one or more AVs. After the detection of the condition, the route preview platform may determine a navigation route that does not go through the area.

The route preview platform further generates a route preview animation for a navigation route. The animation may include graphical objects that represent real-world objects that the user can perceive if the user travels on the navigation route. The real-world objects may include real-world objects that the user may be interested in, points of interests, or other real-world objects. A graphical object that represents a real-world object may be generated based on data from one or more AVs that operate in an environment surrounding the real-world object. The route preview platform may receive multiple datasets from different AVs for a single real-world object. The route preview platform may combine all of the datasets to generate the graphical object. Alternatively, the route preview platform may select some of the datasets to generate the graphical object, e.g., based on recency of the datasets. The animation may also include other graphical objects. An example is a message box displaying a message related to the navigation route, such as a message describing a real-world object, etc. The message box may be geotagged. Another example is an interactive graphical object with which the user can interact with, e.g., through a client device associated with the user.

The route preview platform may further extend the navigation route by determining one or more auxiliary routes. An auxiliary route may be a route between a point on the navigation route to another point outside the navigation route. The point outside of the navigation route may be a point of interest of the user or a third party. The route preview platform can generate one or more auxiliary animations for an auxiliary route and attach the auxiliary animations to the route preview animation.

By taking advantage of information collected by AVs, the route preview platform can provide better route previews than conventional technologies. Animated route previews, compared with static street view images, can provide more information of real-world scenes and better help users to understand potential navigation routes. Also, the route preview platform can manage recency of its route preview animations based on recency of data collected by AVs. Further, the data from AVs used to generate route preview animations can be a byproduct of operations of the AVs for other purposes, such as for providing services (e.g., ride service, delivery service, etc.), for testing AVs, and so on. Thus, the cost for generating the route preview animations can be lower than the cost of generating static street view images in conventional route preview services. Route preview animations may not only benefit users who plan to have an AV ride along the routes, but also users who plan to travel along the routes with other travel media (e.g., other types of vehicles, bike, airplane, walking, running, etc.), users who need to plan for a route after AV rides (e.g., a route from a drop-off spot to another location), people with whom the users would like to share their travel plans, users (e.g., AV developers) who need to select a route for testing AVs, users who are interested in marketing activities (e.g., advertisements) along the routes, and so on.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Example System Facilitating Animated Route Preview

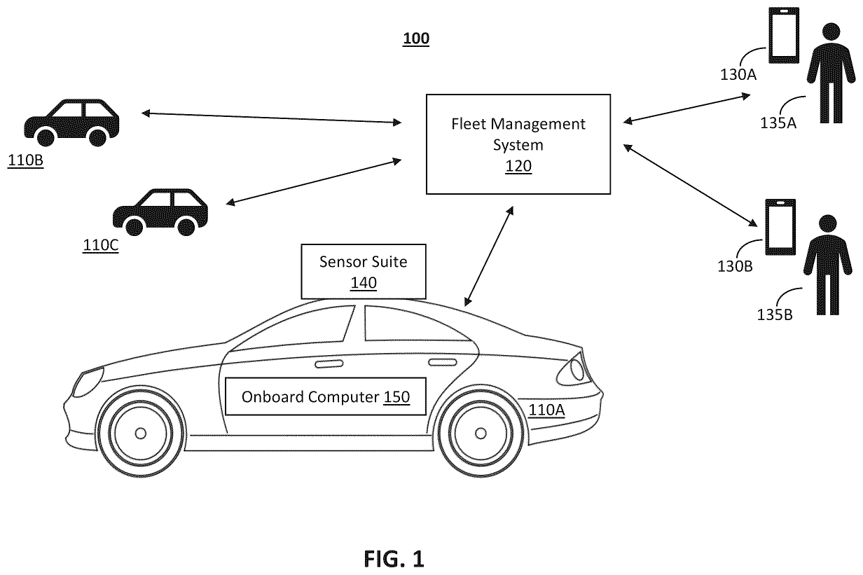

FIG. 1 illustrates a system 100 including a fleet of AVs that can provide services to users, according to some embodiments of the present disclosure. The system 100 includes AVs 110A-110C (collectively referred to as “AVs 110” or “AV 110”), a fleet management system 120, and client devices 130A and 130B (collectively referred to as “client devices 130” or “client device 130”). The client devices 130A and 130B are associated with users 135A and 135B, respectively. The AV 110A includes a sensor suite 140 and an onboard computer 150. Even though not shown in FIG. 1, the AV 110B or 110C can also include a sensor suite 140 and an onboard computer 150. In other embodiments, the system 100 may include more, fewer, or different components. For example, the fleet of AVs 110 may include a different number of AVs 110 or a different number of client devices 130.

The fleet management system 120 manages the fleet of AVs 110. The fleet management system 120 may manage one or more services that the fleet of AVs 110 provides to the users 135. An example service is a ride service, e.g., an AV 110 provides a ride to a user 135 from a first location to a second location. Another example service is a delivery service, e.g., an AV 110 delivers one or more items from or to the user 135. The fleet management system 120 can select one or more AVs 110 (e.g., AV 110A) to perform a particular service, and instructs the selected AV to drive to one or more particular locations associated with the service (e.g., a first address to pick up user 135A, and a second address to pick up user 135B). The fleet management system 120 also manages fleet maintenance tasks, such as fueling, inspecting, and servicing of the AVs. As shown in FIG. 1, the AVs 110 communicates with the fleet management system 120. The AVs 110 and fleet management system 120 may connect over a network, such as the Internet.

In some embodiments, the fleet management system 120 receives service requests for the AVs 110 from the client devices 130. In an example, the user 135A accesses an app executing on the client device 130A and requests a ride from a pickup location (e.g., the current location of the client device 130A) to a destination location. The client device 130A transmits the ride request to the fleet management system 120. The fleet management system 120 selects an AV 110 from the fleet of AVs 110 and dispatches the selected AV 110A to the pickup location to carry out the ride request. In some embodiments, the ride request further includes a number of passengers in the group. In some embodiments, the ride request indicates whether a user 135 is interested in a shared ride with another user traveling in the same direction or along a same portion of a route. The ride request, or settings previously entered by the user 135, may further indicate whether the user 135 is interested in interaction with another passenger.

The fleet management system 120 also facilitates a route preview platform that provides animated route previews to users, such as users 135. An animated route preview includes an animation that illustrates a real-world navigation route. The route preview platform enables the users 135 to request animated route previews. Users 135 who can request animated route previews may include users 135 who are interested in services provided by the AVs 110 (such as a person who wants to request a ride service provided by an AV 110), users 135 who need animated route previews to evaluate or develop the AVs 110 (e.g., a person who needs to select a route for testing an AV 110), users 135 who need route previews to plan activities (e.g., a person who needs to select a route for biking, walking, running, or other activities), and so on.

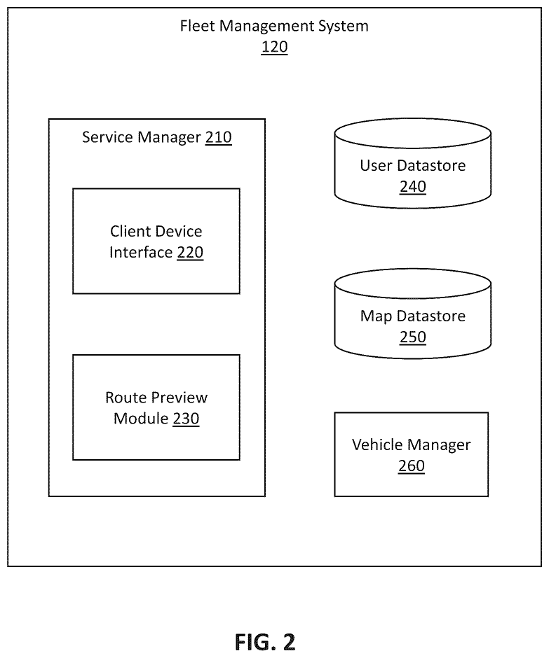

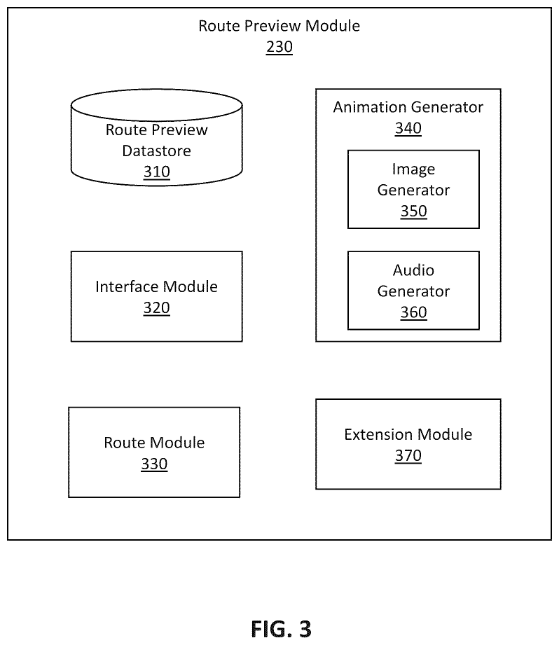

The route preview platform can determine one or more navigation routes for a request for animated route preview, e.g., based on information in the request, data from one or more AVs 110 (e.g., sensor data, perceptions, etc.), or other information associated with the navigation routes. The route preview platform may allow a user to select or modify a navigation route. The route preview platform further generates an animation that illustrates a navigation route. The animation includes images (e.g., 2D or 3D images) showing objects along the navigation route. The animation may also include audio that illustrates sound along the navigation route. The route preview platform can provide the animation for display to the user 135 and may allow the user to interact with the animation. In some embodiments, the route preview platform may extend a route preview animation by including one or more auxiliary animations. An auxiliary animation is an animation that illustrates an auxiliary route that is not part of the navigation route illustrated in the route preview animation but is associated with the navigation route. For instance, an auxiliary route may be a route that connects a point in the navigation route (e.g., a starting point, intermediate stop, or final stop of the navigation route) with a point of interest outside the navigation route. More details regarding the route preview platform are provided below in conjunction with FIGS. 2 and 3.

A client device 130 is a device capable of communicating with the fleet management system 120, e.g., via one or more networks. The client device 130 can transmit data to the fleet management system 120 and receive data from the fleet management system 120. The client device 130 can also receive user input and provide outputs. In some embodiments, outputs of the client devices 130 are in human-perceptible forms, such as text, graphics, audio, video, and so on. The client device 130 may include various output components, such as monitors, display screens, speakers, headphones, projectors, and so on. The client device 130 also includes various input components, such as keyboard, mouse, touch pad, touch screen, and so on. The output components of the client device 130 can present animations (e.g., route preview animations) to the user 135. The input components of the client device 130 can enable the user 135 to interact with animations. The client device 130 may be a desktop or a laptop computer, a smartphone, a mobile telephone, a personal digital assistant (PDA), a headset that can display virtual reality (VR), augmented reality (AR), or mixed reality (MR) content, or another suitable device.

In some embodiments, a client device 130 executes an application allowing a user 135 of the client device 130 to interact with the fleet management system 120. For example, a client device 130 executes a browser application to enable interaction between the client device 130 and the fleet management system 120 via a network. In another embodiment, a client device 130 interacts with the fleet management system 120 through an application programming interface (API) running on a native operating system of the client device 130, such as IOS® or ANDROID™. The application may be provided and maintained by the fleet management system 120. The fleet management system 120 may also update the application and provide the update to the client device 130.

In some embodiments, a user 135 may submit requests (e.g., requests for services provided by the AVs 110, requests for animated route previews, etc.) to the fleet management system 120 through a client device 130. A client device 130 may provide its user 135 a user interface, through which the user 135 can make service requests, such as ride request (e.g., a request to pick up a person from a pickup location and drop off the person at a destination location), delivery request (e.g., a request to delivery one or more items from a location to another location), and so on. The user interface may allow users 135 to provide locations (e.g., pickup location, destination location, etc.) or other information that would be needed by AVs 110 to provide services requested by the users 135. The client device 130 may also provide the user 135 a user interface (or the same user interface) through which the user 135 can interact with the route preview platform. For instance, the user interface enables the user to submit a request for animated route preview to the route preview platform. The user interface can further provide the user 135 an animation generated by the route preview platform in response to the request.

The user interface allows the user 135 to view the animation. The client device 130 may display the animation as VR, AR, or MR content. The user interface may also allow the user 135 to interact with the animation. For instance, the user interface allows the user 135 to interact with interactive elements in the animation. In embodiments where the route preview platform updates the animation based on the interaction of the user 135, the user interface can provide the updated animation to the user.

The AV 110 is preferably a fully autonomous automobile, but may additionally or alternatively be any semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain sensors of the sensor suite 140 are described further in relation to FIG. 2.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. The onboard computer 150 may be preferably a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

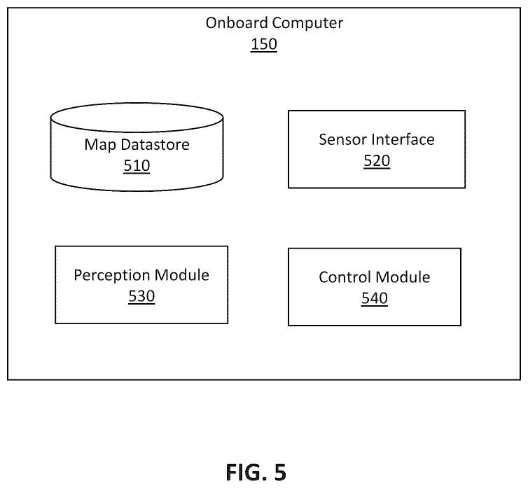

In some embodiments, the onboard computer 150 is in communication with the fleet management system 120, e.g., through a network. The onboard computer 150 may receive instructions from the fleet management system 120 and control behavior of the AV 110 based on the instructions. For example, the onboard computer 150 may receive from the fleet management system 120 an instruction for providing a ride to a user 135. The instruction may include information of the ride (e.g., pickup location, drop-off location, intermediate stops, etc.), information of the user 135 (e.g., identifying information of the user 135, contact information of the user 135, etc.). The onboard computer 150 may determine a navigation route of the AV 110 based on the instruction. As another example, the onboard computer 150 may receive from the fleet management system 120 a request for sensor data to be used by the route preview platform. The onboard computer 150 may control one or more sensors of the sensor suite 140 to detect the user 135, the AV 110, or an environment surrounding the AV 110 based on the instruction and further provide the sensor data from the sensor suite 140 to the fleet management system 120. The onboard computer 150 may transmit other information requested by the fleet management system 120, such as perception of the AV 110 that is determined by a perception module of the onboard computer 150, historical data of the AV 110, and so on. Certain aspects of the onboard computer 150 are described further in relation to FIG. 5.

### Example Fleet Management System

FIG. 2 is a block diagram showing the fleet management system, according to some embodiments of the present disclosure. The fleet management system 120 includes a service manager 210, a user datastore 240, a map datastore 250, and a vehicle manager 260. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 150.

The service manager 210 manages services that the fleet of AVs 110 can provide. The service manager 210 includes a client device interface 220 and a route preview module 230. The client device interface 220 provides interfaces to client devices, such as headsets, smartphones, tablets, computers, and so on. For example, the client device interface 220 may provide one or more apps or browser-based interfaces that can be accessed by users, such as the users 135, using client devices, such as the client devices 130. The client device interface 220 enables the users to submit requests to a ride service provided or enabled by the fleet management system 120. In particular, the client device interface 220 enables a user to submit a ride request that includes an origin (or pickup) location and a destination (or drop-off) location. The ride request may include additional information, such as a number of passengers traveling with the user, and whether or not the user is interested in a shared ride with one or more other passengers not known to the user.

The client device interface 220 can also enable users 135 to request animated route previews. The client device interface 220 can provide one or more options for a user 135 to submit a request for a route preview animation through a client device 130 associated with the user 135. In some embodiments, the client device interface 220 allows the user 135 to provide one or more parameters for a navigation route that the user 135 wants to preview. Example parameters include location parameter, time parameter, travel medium parameter, distance parameter, entertainment parameter, and so on. A location parameter may include one or more locations, such as location of a starting point, location of an intermediate stop along the navigation route, location of a final stop of the navigation route, and so on. A time parameter may include a time window for the navigation, a particular date or time that the navigation starts or ends, etc. A travel medium parameter may indicate one or more types of travel medium, such as AVs 110, other vehicles, buses, planes, bikes, walking, running, and so on. A distance parameter may include a preference for a shorter or longer navigation distance, a maximum distance, a minimum distance, and so on. An entertainment parameter may indicate the user's preference for views along the navigation route (e.g., natural scenes, street views, landmarks, or other views that the user prefers to have or prefers to avoid), preference for activities that can be performed or avoided along the navigation route (e.g., options for entertainment activities, options for food or drinks, options for shopping, etc.), and so on.

The client device interface 220 can also facilitate presentation of route preview animations to users 135. For instance, the client device interface 220 may support and maintain user interfaces running on client devices 130, such as the user interfaces described above in conjunction with the client devices 130 in FIG. 1. The client device interface 220 can further facilitate interactions of users 135 with route preview animations.

The route preview module 230 facilitates a route preview platform, e.g., the route preview platform described above. The route preview module 230 may receive requests for animated route previews through the client device interface 220 or the onboard computer 150. In response to a request for animated route preview, the route preview module 230 may determine a navigation route based on the request and generate an animation that illustrates the navigation route. The animation provides a preview of the navigation route. The animation may show real-world objects that the user 135 may perceive if the user 135 travels along the navigation route. The animation may also include other objects, such as objects that provide information about a real-world object, objects that the user 135 may interact with, and so on. In some embodiments, the route preview module 230 generates the animation based on how or when the user intends to travel along the navigation route. The user 135 may indicate how or when she/he intends to travel along the navigation route in the request for animated route preview. The route preview module 230 can extend the animation by adding additional animation that shows an additional route to or from a point in the navigation route. The additional route may include a point of interest that is outside the navigation route. The route preview module 230 may determine the point of interest based on an interest of the user 135, a requirement of a third party, or other factors. Certain aspects of the route preview module 230 are described below in conjunction with FIG. 3.

The user datastore 240 stores information associated with users 135. The user datastore 240 may store information associated with one or more requests for animated route preview made by a user 135, such as information of navigation routes determined for the user 135, route preview animations generated for the user 135, interactions of the user 135 with route preview animations, and so on. The user datastore 240 may also store information associated with rides requested or taken by the user 135. For instance, the user datastore 240 may store information of a ride currently being taken by a user 135, such as an origin location and a destination location for the user's current ride. The user datastore 240 may also store historical ride data for a user 135, including origin and destination locations, dates, and times of previous rides taken by a user. In some cases, the user datastore 240 may further store future ride data, e.g., origin and destination locations, dates, and times of planned rides that a user has scheduled with the ride service provided by the AVs 110 and fleet management system 120. Some or all of the information of a user 135 in the user datastore 240 may be received through the client device interface 220, an onboard computer (e.g., the onboard computer 150), a sensor suite of AVs 110 (e.g., the sensor suite 140), a third-party system associated with the user and the fleet management system 120, or other systems or devices.

In some embodiments, the user datastore 240 also stores data indicating user interests, such as user interests associated with route preview, user interest associated with rides in AVs 110, and so on. The fleet management system 120 may include one or more learning modules (not shown in FIG. 2) to learn user interests based on user data. For example, a learning module may compare locations in the user datastore 240 with map datastore 250 to identify places the user has visited or plans to visit. For example, the learning module may compare an origin or destination address for a user in the user datastore 240 to an entry in the map datastore 250 that describes a building at that address. The map datastore 250 may indicate a building type, e.g., to determine that the user was picked up or dropped off at an event center, a restaurant, or a movie theater. In some embodiments, the learning module may further compare a date of the ride to event data from another data source (e.g., a third-party event data source, or a third-party movie data source) to identify a more particular interest, e.g., to identify a performer who performed at the event center on the day that the user was picked up from an event center, or to identify a movie that started shortly after the user was dropped off at a movie theater. This interest (e.g., the performer or movie) may be added to the user datastore 240.

The map datastore 250 stores a detailed map of environments through which the AVs 110 may travel. The map datastore 250 includes data describing roadways, such as e.g., locations of roadways, connections between roadways, roadway names, speed limits, traffic flow regulations, toll information, etc. The map datastore 250 may further include data describing buildings (e.g., locations of buildings, building geometry, building types), and data describing other objects (e.g., location, geometry, object type) that may be in the environments of AV 110. The map datastore 250 may also include data describing other features, such as bike lanes, sidewalks, crosswalks, traffic lights, parking lots, signs, billboards, etc.

Some of the map datastore 250 may be gathered by the fleet of AVs 110. For example, images obtained by the exterior sensors 410 of the AVs 110 may be used to learn information about the AVs' environments. As one example, AVs may capture images in a residential neighborhood during a Christmas season, and the images may be processed to identify which homes have Christmas decorations. The images may be processed to identify particular features in the environment. For the Christmas decoration example, such features may include light color, light design (e.g., lights on trees, roof icicles, etc.), types of blow-up figures, etc. The fleet management system 120 and/or AVs 110 may have one or more image processing modules to identify features in the captured images or other sensor data. This feature data may be stored in the map datastore 250. In some embodiments, certain feature data (e.g., seasonal data, such as Christmas decorations, or other features that are expected to be temporary) may expire after a certain period of time. In some embodiments, data captured by a second AV 110 may indicate that a previously-observed feature is no longer present (e.g., a blow-up Santa has been removed) and in response, the fleet management system 120 may remove this feature from the map datastore 250.

The vehicle manager 260 manages and communicates with the fleet of AVs 110. The vehicle manager 260 assigns the AVs 110 to various tasks and directs the movements of the AVs 110 in the fleet. The vehicle manager 260 includes a vehicle manager 260 and an AV 110 interface 290. In some embodiments, the vehicle manager 260 includes additional functionalities not specifically shown in FIG. 2. For example, the vehicle manager 260 instructs AVs 110 to drive to other locations while not servicing a user, e.g., to improve geographic distribution of the fleet, to anticipate demand at particular locations, etc. The vehicle manager 260 may also instruct AVs 110 to return to an AV 110 facility for fueling, inspection, maintenance, or storage.

In some embodiments, the vehicle manager 260 selects AVs from the fleet to perform various tasks and instructs the AVs to perform the tasks. For example, the vehicle manager 260 receives a ride request from the client device interface 220. The vehicle manager 260 selects an AV 110 to service the ride request based on the information provided in the ride request, e.g., the origin and destination locations. If multiple AVs 110 in the AV 110 fleet are suitable for servicing the ride request, the vehicle manager 260 may match users for shared rides based on an expected compatibility. For example, the vehicle manager 260 may match users with similar user interests, e.g., as indicated by the user datastore 240. In some embodiments, the vehicle manager 260 may match users for shared rides based on previously-observed compatibility or incompatibility when the users had previously shared a ride.

The vehicle manager 260 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle manager 260 may select AVs for service in a manner that optimizes one or more additional factors, including fleet distribution, fleet utilization, and energy consumption. The vehicle manager 260 may interface with one or more predictive algorithms that project future service requests and/or vehicle use, and select vehicles for services based on the projections.

The vehicle manager 260 transmits instructions dispatching the selected AVs. In particular, the vehicle manager 260 instructs a selected AV 110 to drive autonomously to a pickup location in the ride request and to pick up the user and, in some cases, to drive autonomously to a second pickup location in a second ride request to pick up a second user. The first and second user may jointly participate in a virtual activity, e.g., a cooperative game or a conversation. The vehicle manager 260 may dispatch the same AV 110 to pick up additional users at their pickup locations, e.g., the AV 110 may simultaneously provide rides to three, four, or more users. The vehicle manager 260 further instructs the AV 110 to drive autonomously to the respective destination locations of the users.

FIG. 3 is a block diagram showing the route preview module 230, according to some embodiments of the present disclosure. As described above, the route preview module 230 can provide animated route previews. The route preview module 230 includes a route preview datastore 310, an interface module 320, a route module 330, an animation generator 340, and an extension module 370. In alternative configurations, different and/or additional components may be included in the route preview module 230. Further, functionality attributed to one component of the route preview module 230 may be accomplished by a different component included in the route preview module 230, a different component included in the fleet management system 120, or a different system than those illustrated, such as the onboard computer 150.

The route preview datastore 310 stores data received, generated, and used by the route preview module 230. For example, the route preview datastore 310 stores information received by the interface module 320. As another example, the route preview datastore 310 stores data used by the route module 330 for determining navigation routes and data used by the animation generator 340 for generating route preview animations. The route preview datastore 310 may also store data generated by the route module 330 and the animation generator 340, such as information describing navigation routes, images for navigation routes, audio for navigation routes, and so on.

The interface module 320 facilitates communications of the route preview module with other components of the fleet management system 120, other systems, or devices. In some embodiments, the interface module 320 receives route preview requests made by users, e.g., from the client device interface 220, onboard computers of AVs, or other devices that users may use to interact with the route preview module 230. The interface module 320 may also communicate with AVs, e.g., onboard computers of AVs. The interface module 320 may send requests for sensor data to AVs and receive requested sensor data from the AVs. The interface module 320 may provide received data to other components of the route preview module 230. For example, the interface module 320 may provide received route preview request to the route module 330 for the route module 330 to determine a navigation route. As another example, interface module 320 may provide received route preview request or received sensor data to the animation generator 340 for the animation generator 340 to generate animation.

In some embodiments, the interface module 320 also facilitates a user interface (e.g., a graphical user interface (GUI)) supported and maintained by the route preview module 230. For instance, the interface module 320 facilitates a user interface associated with a route preview animation. The route preview animation may include one or more interactive elements that allow users to interact with the route preview animation. An interactive element may be included in the animation itself. Example interactive elements may include input elements that allow users to provide input to the route preview animation (e.g., checkboxes, buttons, dropdown lists, text fields, time pickers, etc.), navigational elements that allow users to navigate content in the route preview animation (e.g., sliders, search fields, tags, icons, etc.) informational elements that if selected by users, can provide additional information to users (e.g., message boxes, modal windows, icons, tooltips, notifications, etc.), other types of interactive elements, or some combination thereof. The interface module 320 can receive user interactions with route preview animations and provide the user interactions to the route module 330 or the animation generator 340 to modify navigation routes or animations based on the user interactions.

The route module 330 determines navigation routes for animated route previews. The route module 330 may determine a navigation route based on a request for animated route preview. In some embodiments, the route module 330 uses information in the request to determine the navigation route. The information in the request may include one or more locations (e.g., location of a starting point, location of destination, etc.), preference for navigation time (e.g., a time window for the navigation, a particular date or time that the navigation starts or ends, etc.), preference for travel medium (e.g., AVs, other vehicles, buses, planes, bikes, walking, etc.), preference for navigation distance (e.g., preference for a shorter or longer navigation distance, a maximum distance, a minimum distance, etc.), preference for views along the navigation route (e.g., natural scenes, street views, landmarks, or other views that the user prefers to have or prefers to avoid), preference for activities that can be performed or avoided along the navigation route (e.g., options for entertainment activities, options for food or drinks, options for shopping, etc.), and so on.

In an example, the route module 330 determines a route that connects a location of a starting point and a location of a destination in the request. In embodiments where the request includes multiple destinations, the route module 330 can determine a route that includes all the destinations. The route module 330 may determine a sequence of the destinations based on a sequence specified in the request or other information in the request, such as preferred navigation distance or time. The route module 330 may retrieve data from the map datastore 250 of the fleet management system 120 and use the data in the map datastore 250 to determine the navigation route. For example, the route module 330 may use the data in the map datastore 250 to identify an area that has the preferred view specified in the request and determine a navigation route through the area. As another example, the route module 330 may identify a location where the user may perform a preferred activity specified in the request and determine a navigation route including the location.

In some embodiments, the route module 330 determines a plurality of candidate routes and selects one of the candidate routes as the navigation route. For instance, the route module 330 may identify multiple candidate routes that meet some or all of the requirements in the request. The route module 330 may select one of the candidate routes based on one or more conditions of the candidate routes. For instance, the route module 330 may determine not to select a candidate route given an interfering condition. An interfering condition is a condition that can interfere with the user's travel along the candidate route. An example interfering condition may be a traffic condition, such as traffic jam, construction, accident, road closure, obstacles, or other traffic conditions that can interfere with a traffic flow along at least a portion of the candidate route. Another example interfering condition may be a lighting condition, such as poor lighting when it is dark that can interfere with the user's walking or running along the candidate route. The route module 330 may determine one or more interfering conditions based on information in the request (such as travel medium, time of interest, etc.) and determine whether a candidate route has any of the interfering conditions. For instance, the route module 330 may determine different interfering conditions for a request specifying that the preferred travel medium is an AV than a request specifying that the preferred travel medium is walking, as conditions interfering navigation of AVs can be different from conditions interfering walking.

The route module 330 may detect an interfering condition along a candidate route based on a perception or sensor data from one or more AVs 110 that operated along at least a portion of the candidate route. In some embodiments, the route module 330 may request, e.g., through the vehicle manager 260, one or more AVs 110 that is operating or is going to operate along at least a portion of the candidate route to provide information regarding conditions on the candidate route. The route module 330 may also detect the condition based on other data, such as data stored in the map datastore 250, other data that indicate conditions along the navigation route, or some combination thereof.

In some embodiments, after an interfering condition is detected, the route module 330 may further determine whether the interfering condition is still present at a time of interest, e.g., a current time or a navigation time specified in the request from the user. In an embodiment, the route module 330 may request, e.g., through the vehicle manager 260, one or more AVs 110 that would operate at the time of interest along the portion of the candidate route where the inferring condition occurred to capture sensor data for determining whether the interfering condition is present.

In another example, the route module 330 may determine a threshold duration of time for the detected interfering condition and determine whether the threshold duration of time has passed or will pass since the interfering condition was detected. The route module 330 may determine a threshold duration of time based on a classification of the interfering condition, AV sensor data capturing information associated with the interfering condition, and so on. In an example, the route module 330 may determine that the threshold duration of time for a road closure is 5 days given AV sensor data that captures a traffic notification on the road that the road will reopen in 5 days.

The route module 330 may determine whether a difference between the time when the interfering condition was detected (“detection time”) and the time of interest is beyond the threshold duration of time. In some embodiments (e.g., embodiments where the interfering condition is detected by one or more AVs 110), the detection time can be the time that the one or more AVs 110 operated along the portion of the candidate route where the interfering condition occurred. In response to determining that the difference is beyond the threshold duration of time, the route module 330 may determine that the interfering condition is not or will not be present at the time of interest; otherwise, the route module 330 may determine that the interfering condition is or will be present at the time of interest and not select the candidate route as the navigation route.

In embodiments where there are multiple candidate routes that are suitable for the user, the route module 330 may rank the candidate routes. For example, the route module 330 may determine a ranking score based on an estimation of the user's preference for a candidate route. The estimation of the user's preference may be based on historical data of the user (e.g., data stored in the user datastore 240), information in the request, or other data that may indicate the user's preference. The route module 330 may rank the candidate routes based on their ranking scores and select the candidate route that ranked highest as the navigation route for the user.

After selecting one or more navigation routes, the route module 330 may provide the user a recommendation for the one or more navigation routes. The recommendation may be presented in a user interface that allows the user to view information of the navigation routes, select a navigation route, modify a navigation route, and so on. The route module 330 may also generate one or more messages explaining why or why not a navigation route is recommended. Such a message may be included in the route preview animation to be presented to the user. Alternatively, the message may be provided to the user separately.

The animation generator 340 generates animations to be used for route previews. The animation generator 340 may receive information of a navigation route from the route module 330 and generate one or more animations illustrating the navigation route. As shown in FIG. 3, the animation generator 340 includes an image generator 350 and an audio generator 360. In alternative configurations, different and/or additional components may be included in the animation generator 340. Further, functionality attributed to one component of the animation generator 340 may be accomplished by a different component included in the animation generator 340, a different component included in the route preview module 230 or fleet management system 120, or a different system than those illustrated, such as the onboard computer 150.

The image generator 350 generates graphical objects in route preview animations. A graphical object is a computer-generated graphic that illustrates an object. Example objects include streets, buildings, street signs, traffic signs, vehicles, trees, plants, people, animals, mountains, rivers, and so on. A graphical object may include a 2D or 3D image. Certain graphical objects can be animated. A graphical object may be a graphical representation of a real-world object. The image generator 350 may generate graphical objects for a navigation route based on real-world objects perceivable by a user if the user travels along the navigation route. The image generator 350 may generate one or more graphical representations for a real-world object. A graphical representation of a real-world object may include one or more features of the object, such as shape, size, color, contour, and so on. In some embodiments, the image generator 350 may detect one or more private features of a real-world object. A private feature is a feature that includes private information that if disclosed, may cause infringement of privacy. In the process of generating the graphical representation, the image generator 350 may remove or modify a private feature. For example, a graphical representation of a person may not include certain facial features of the person for protecting privacy of the person.

The image generator 350 may generate a graphical representation of a real-world object based on sensor data from one or more AVs 110 that have detected the object. The graphical representation may be a 2D or 3D model of the object. In some embodiments, the image generator 350 may use data from a single sensor or a single AV 110 (e.g., an image captured by a camera of an AV) to generate a graphical representation of an object. The image generator 350 may obtain (e.g., request or retrieve) a sensor data set from an AV 110 that captures the object, e.g., while the AV 110 operates in an environment including the object. The sensor data set may include data generated by one or more sensors of the AV 110. In embodiments where the image generator 350 can obtain multiple sensor data sets, e.g., from multiple AVs 110, the image generator 350 may determine whether the sensor data sets are redundant. For instance, the image generator 350 may determine that a first sensor data set from a first AV 110 includes the same information (e.g., same images or other types of information) as a second sensor data set from a second AV 110. The image generator 350 can also determine recency of each sensor data set and select the most recent sensor data set. For instance, the image generator 350 may determine a first time when the first AV 110 captured the sensor data (e.g., a time that the first AV 110 operated in an environment surrounding the object, e.g., along at least a portion of the navigation route) and a second time when the second AV 110 captured the sensor data (e.g., a time that the second AV 110 operated in an environment surrounding the object, e.g., along at least a portion of the navigation route). The image generator 350 further determines which time is the later time and uses the sensor data of the later time to generate the graphical representation of the object.

In some embodiments, the image generator 350 may combine sensor data from different sensors or even different AVs 110 to generate the graphical representation of the object. For example, the image generator 350 may generate the graphical representation by combining multiple images that captured the object from different angles. As another example, the image generator 350 may generate a 3D model of an object based on a point cloud from a LIDAR sensor detecting the object. The image generator 350 can generate the graphical representation by combining the 3D model with one or more images of the object. In some embodiments, such as embodiments where the image generator 350 determines that additional sensor data (e.g., an image of the object from a particular angle) is needed to generate the graphical representation, the image generator 350 may instruct an AV 110 that is navigating or will navigate in an environment surrounding the object and capture the additional sensor data. The AV 110 may navigate in the environment to provide a service, such as a ride service or delivery service, and the AV 110 can capture the additional sensor data during the performance of the service. Alternatively, the AV 110 may navigate to the environment in accordance with an instruction from the image generator. The image generator 350 may provide the AV 110 an instruction that specifies one or more sensors that can capture the additional sensor data. The instruction may also include one or more settings for the sensors, such as orientation, resolution, accuracy, focal length, and so on. The image generator 350 may receive the additional sensor data from the AV 110 and further finishes the generation of the graphical representation.

In some embodiments, the image generator 350 may input sensor data into a trained model, and the trained model outputs one or more graphical representations. The image generator 350 may train the model using different machine learning techniques, such as linear support vector machine (linear SVM), boosting for other algorithms (e.g., AdaBoost), neural networks (e.g., convolutional neural network, graphical neural network, etc.), logistic regression, naïve Bayes, memory-based learning, random forests, bagged trees, decision trees, boosted trees, or boosted stumps—may be used in different embodiments.

In addition or alternative to sensor data from AVs 110, the image generator 350 may use other data to generate graphical representations. The image generator 350 may use a perception (e.g., a classification) of an object by an AV 110 to generate a graphical representation of the object. The image generator 350 may also use information in a request for animated route preview to generate graphical representations for the requested animation. In an example, the image generator 350 may generate a graphical representation of an object based on a travel medium (e.g., AV, bike, plane, etc.) indicated in the request. For instance, the image generator 350 may estimate an angle of the user viewing the object (“user's viewing angle”) or a moving speed of the user when the user travels along the navigation route with the travel medium, and generate the graphical representation of the object based on the user's viewing angle, moving speed, or both. For a user's request for an animated route preview for a potential ride in an AV 110, the image generator 350 may generate a graphical representation of a building that represents the user's view of the building as if the user is sitting in an AV 110 driving on a street where the building is located. For a user's request for an animated route preview for a ride in an airplane, the image generator 350 may generate a different graphical representation of the same building that represents the user's view of the building as if the user is in a plane flying above the building.

In another example, the image generator 350 may generate a graphical representation of an object based on a time of interest indicated in the request. The image generator 350 may determine a lighting condition for the object based on the time of interest. For instance, the lighting condition for the object can be different at different times of the day. The image generator 350 may estimate one or more colors or levels of brightness of the object under the lighting condition and generate a graphical representation showing the estimated colors or brightness.

The image generator 350 may generate interactive graphical icons with which users can interact, e.g., through a client device 130. An interactive graphical icon may be a graphical representation of a real-world object perceivable by the user if the user travels along the navigation route. Taking a building on the navigation route for example, the image generator 350 may generate an interactive image of the building. The user may be able to interact with the image (e.g., click the image) to get information of the building (e.g., products or services provided in the building). Alternatively, an interactive graphical icon may not represent any real-world object. In the example of the building, the image generator 350 may alternatively generate an interactive icon (e.g., a callout icon) that does not represent the building, but the user can interact with the icon to get information of the building.

The image generator 350 may generate an animation for a navigation route by combining the graphical objects that the image generator 350 has generated for the navigation route. The image generator 350 may provide smooth transitions between graphical objects for producing a smooth animation, e.g., by using image processing techniques. In an example, the image generator 350 may input the graphical objects into a model that has been trained using machine learning techniques (such as the techniques listed above), and the model outputs a smooth animation. In some embodiments, the image generator 350 receives audio content from the audio generator 360 and can incorporate the audio content into the animation. In alternative embodiments, the image generator 350 may provide an animation to the audio generator 360 and the audio generator 360 can insert audio content into the animation.

The audio generator 360 generates audio content for animated route preview. In some embodiments, the audio generator 360 generates audio content for a route preview animation based on objects shown in the animation. The audio generator 360 may determine whether an object shown in the animation should be associated with audio, e.g., based on a classification of the object. For example, the audio generator 360 may determine that a tree should not be associated with any audio as the tree does not make sound. In contrast, the audio generator 360 may determine that a red traffic light for pedestrians should be associated with an audio that alerts pedestrians that the light is red and walking across the street is not permitted.

After determining that an object illustrated in the animation should be associated with audio, the audio generator 360 can generate audio content for the object. The audio generator 360 may generate the audio content based on one or more attributes of the object, such as classification, location, and so on. In the example of the red traffic light for pedestrians, the audio generator 360 may generate audio content the represents the alert. The audio content may be computer-generated artificial sound. In some embodiments, the audio generator 360 may use audio data captured by acoustic sensors of AVs 110 to generate the audio content. The audio generator 360 can determine if the captured audio has any private information and in response to determining that there is private information, the audio generator 360 can remove or modify the private information to protect privacy.

The extension module 370 may extend a navigation route determined by the route module 330. The extension module 370 can generate one or more ancillary routes for the navigation route. An ancillary route may be a route from a starting point or destination of the navigation route to a point of interest. In some embodiments, the point of interest is not indicated in the request for animated route preview. The extension module 370 may identify the point of interest based on an interest (explicit or inferred interest) of the user, a spatial proximity of the point of interest to the starting point or destination, a request from a third party (e.g., a third party associated with the point of interest), other factors, or some combination thereof. The point of interest may be a landmark, a business (e.g., a store, restaurant, coffee shop, movie theater, club, etc.), a park, a school, and so on. In some embodiments, the ancillary route may be a route for walking. For instance, the user may request an animated route preview for a ride in an AV 110, the extension module 370 may determine an ancillary route for the user to walk to the point of interest before the AV 110 picks up the user or an ancillary route for the user to walk to the point of interest after the AV 110 drops off the user.

The extension module 370 may generate, or instruct the animation generator 340, an ancillary animation for an ancillary route. The extension module 370 may attach the ancillary animation to the animation of the navigation route based on a relationship between the ancillary route and the navigation route. In an example where the ancillary route is a route from a point of interest to a starting point of the navigation route, the ancillary animation may be placed before the animation. In another example where the ancillary route is a route from a point of interest to or from an intermediate stop of the navigation route, the ancillary animation may be inserted into the animation, e.g., after the frame of the animation showing that the intermediate stop is reached. In yet another example where the ancillary route is a route from a point of interest from the final stop of the navigation route, the ancillary animation may be placed after the animation. In some embodiments, the ancillary animation is integrated with the animation, which results in a single continuous animation. In other embodiments, the ancillary animation is added to the animation through an interactive icon in a user interface. The user interface allows the user to view or ignore the ancillary animation. The user, if interested in the ancillary animation, may interact with the interactive icon, after which the ancillary animation can be presented to the user. The user may also interact with the ancillary animation, e.g., to zoom in or out, to move, or to edit an object in the ancillary animation.

### Example Sensor Suite

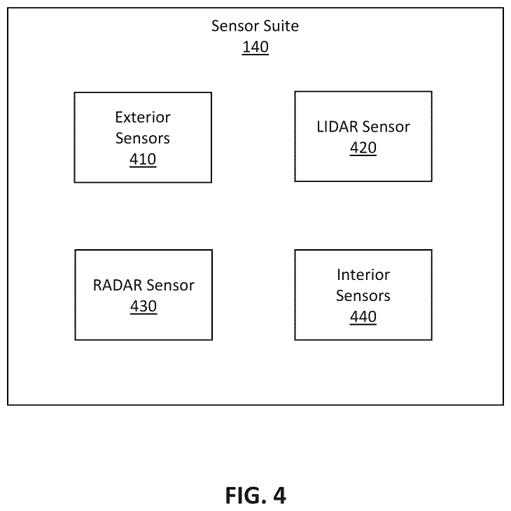

FIG. 4 is a block diagram showing the sensor suite 140, according to some embodiments of the present disclosure. The sensor suite 140 includes exterior sensors 410, a LIDAR sensor 420, a RADAR sensor 430, and interior sensors 440. The sensor suite 140 may include any number of the types of sensors shown in FIG. 4, e.g., one or more exterior sensors 410, one or more LIDAR sensors 420, etc. The sensor suite 140 may have more types of sensors than those shown in FIG. 4, such as the sensors described with respect to FIG. 1. In other embodiments, the sensor suite 140 may not include one or more of the sensors shown in FIG. 4.

The exterior sensors 410 detect objects in an environment around the AV 110. The environment may include a scene in which the AV 110 operates. Example objects include persons, buildings, traffic lights, traffic signs, vehicles, street signs, trees, plants, animals, or other types of objects that may be present in the environment around the AV 110. In some embodiments, the exterior sensors 410 include exterior cameras having different views, e.g., a front-facing camera, a back-facing camera, and side-facing cameras. One or more exterior sensors 410 may be implemented using a high-resolution imager with a fixed mounting and field of view. One or more exterior sensors 410 may have an adjustable field of views and/or adjustable zooms. In some embodiments, the exterior sensors 410 may operate continually during operation of the AV 110. In an example embodiment, the exterior sensors 410 capture sensor data (e.g., images, etc.) of a scene in which the AV 110 drives. In other embodiment, the exterior sensors 410 may operate in accordance with an instruction from the onboard computer 150 or an external system, such as the route preview module 230 of the fleet management system 120. Some of all of the exterior sensors 410 may capture sensor data of one or more objects in an environment surrounding the AV 110 based on the instruction.

The LIDAR sensor 420 measures distances to objects in the vicinity of the AV 110 using reflected laser light. The LIDAR sensor 420 may be a scanning LIDAR that provides a point cloud of the region scanned. The LIDAR sensor 420 may have a fixed field of view or a dynamically configurable field of view. The LIDAR sensor 420 may produce a point cloud that describes, among other things, distances to various objects in the environment of the AV 110.

The RADAR sensor 430 can measure ranges and speeds of objects in the vicinity of the AV 110 using reflected radio waves. The RADAR sensor 430 may be implemented using a scanning RADAR with a fixed field of view or a dynamically configurable field of view. The RADAR sensor 430 may include one or more articulating RADAR sensors, long-range RADAR sensors, short-range RADAR sensors, or some combination thereof.

The interior sensors 440 detect the interior of the AV 110, such as objects inside the AV 110. Example objects inside the AV 110 include users (e.g., passengers), client devices of users, components of the AV 110, items delivered by the AV 110, items facilitating services provided by the AV 110, and so on. The interior sensors 440 may include multiple interior cameras to capture different views, e.g., to capture views of an interior feature, or portions of an interior feature. The interior sensors 440 may be implemented with a fixed mounting and fixed field of view, or the interior sensors 440 may have adjustable field of views and/or adjustable zooms, e.g., to focus on one or more interior features of the AV 110. The interior sensors 440 may transmit sensor data to a perception module (such as the perception module 530 described below in conjunction with FIG. 5), which can use the sensor data to classify a feature and/or to determine a status of a feature.

In some embodiments, some or all of the interior sensors 440 may operate continually during operation of the AV 110. In other embodiment, some or all of the interior sensors 440 may operate in accordance with an instruction from the onboard computer 150 or an external system, such as the route preview module 230 of the fleet management system 120. The interior sensors 440 may include a camera that can capture images of passengers. The interior sensors 440 may also include a thermal sensor (e.g., a thermocouple, an infrared sensor, etc.) that can capture a temperature (e.g., body temperature) of the passenger. The interior sensors 440 may further include one or more microphones that can capture sound in the AV 110, such as a conversation made by a passenger.

### Example Onboard Computer

FIG. 5 is a block diagram showing the onboard computer 150 of the AV 110 according to some embodiments of the present disclosure. The onboard computer 150 includes map datastore 510, a sensor interface 520, a perception module 530, and a control module 540. In alternative configurations, fewer, different and/or additional components may be included in the onboard computer 150. For example, components and modules for conducting route planning, controlling movements of the AV 110, and other vehicle functions are not shown in FIG. 5. Further, functionality attributed to one component of the onboard computer 150 may be accomplished by a different component included in the onboard computer 150 or a different system, such as the fleet management system 120.

The map datastore 510 stores a detailed map that includes a current environment of the AV 110. The map datastore 510 may include any of the map datastore 250 described in relation to FIG. 5. In some embodiments, the map datastore 510 stores a subset of the map datastore 250, e.g., map data for a city or region in which the AV 110 is located.

The sensor interface 520 interfaces with the sensors in the sensor suite 140. The sensor interface 520 may request data from the sensor suite 140, e.g., by requesting that a sensor capture data in a particular direction or at a particular time. For example, in response to a request for sensor data from the route preview module 230, the sensor interface 520 instructs the sensor suite 140 to capture sensor data of an environment surrounding the AV 110. In some embodiments, the request from the route preview module 230 may specify which sensor(s) in the sensor suite 140 to provide the sensor data, and the sensor interface 520 may request the sensor(s) to capture data. The request may further provide one or more settings of a sensor, such as orientation, resolution, accuracy, focal length, and so on. The sensor interface 520 can request the sensor to capture data in accordance with the one or more settings.

A request for sensor data from the route preview module 230 may be a request for real-time sensor data, and the sensor interface 520 can instruct the sensor suite 140 to immediately capture the sensor data and to immediately send the sensor data to the sensor interface 520. The sensor interface 520 is configured to receive data captured by sensors of the sensor suite 140, including data from exterior sensors mounted to the outside of the AV 110, and data from interior sensors mounted in the passenger compartment of the AV 110. The sensor interface 520 may have subcomponents for interfacing with individual sensors or groups of sensors of the sensor suite 140, such as a camera interface, a LIDAR interface, a RADAR interface, a microphone interface, etc. In embodiments where the sensor interface 520 receives a request for sensor data from the route preview module 230, the sensor interface 520 may provide sensor data received from the sensor suite 140 to the route preview module 230.

The perception module 530 identifies objects and/or other features captured by the sensors of the AV 110. For example, the perception module 530 identifies objects in the environment of the AV 110 and captured by one or more exterior sensors (e.g., the sensors 210-230). The perception module 530 may include one or more classifiers trained using machine learning to identify particular objects. For example, a multi-class classifier may be used to classify each object in the environment of the AV 110 as one of a set of potential objects, e.g., a vehicle, a pedestrian, or a cyclist. As another example, a pedestrian classifier recognizes pedestrians in the environment of the AV 110, a vehicle classifier recognizes vehicles in the environment of the AV 110, etc. The perception module 530 may identify travel speeds of identified objects based on data from the RADAR sensor 430, e.g., speeds at which other vehicles, pedestrians, or birds are traveling. As another example, the perception module 53—may identify distances to identified objects based on data (e.g., a captured point cloud) from the LIDAR sensor 420, e.g., a distance to a particular vehicle, building, or other feature identified by the perception module 530. The perception module 530 may also identify other features or characteristics of objects in the environment of the AV 110 based on image data or other sensor data, e.g., colors (e.g., the colors of Christmas lights), sizes (e.g., heights of people or buildings in the environment), makes and models of vehicles, pictures and/or words on billboards, etc.

The perception module 530 may further process data captured by interior sensors (e.g., the interior sensors 440 of FIG. 2) to determine information about and/or behaviors of passengers in the AV 110. For example, the perception module 530 may perform facial recognition based on sensor data from the interior sensors 440 to determine which user is seated in which position in the AV 110. As another example, the perception module 530 may process the sensor data to determine passengers' states, such as gestures, activities, moods, and so on.

In some embodiments, the perception module 530 fuses data from one or more interior sensors 440 with data from exterior sensors (e.g., exterior sensors 410) and/or map datastore 510 to identify environmental objects that one or more users are looking at. The perception module 530 determines, based on an image of a user, a direction in which the user is looking, e.g., a vector extending from the user and out of the AV 110 in a particular direction. The perception module 530 compares this vector to data describing features in the environment of the AV 110, including the features' relative location to the AV 110 (e.g., based on real-time data from exterior sensors and/or the AV's real-time location) to identify a feature in the environment that the user is looking at.

While a single perception module 530 is shown in FIG. 5, in some embodiments, the onboard computer 150 may have multiple perception modules, e.g., different perception modules for performing different ones of the perception tasks described above (e.g., object perception, speed perception, distance perception, feature perception, facial recognition, mood determination, sound analysis, gaze determination, etc.).

The control module 540 controls operations of the AV 110, e.g., based on information from the sensor interface 520 or the perception module 530. In some embodiments, the control module 540 controls operation of the AV 110 by using a trained model, such as a trained neural network. The control module 540 may provide input data to the control model, and the control model outputs operation parameters for the AV 110. The input data may include sensor data from the sensor interface 520 (which may indicate a current state of the AV 110), objects identified by the perception module 530, or both. The operation parameters are parameters indicating operation to be performed by the AV 110. The operation of the AV 110 may include perception, prediction, planning, localization, motion, navigation, other types of operation, or some combination thereof. The control module 540 may provide instructions to various components of the AV 110 based on the output of the control model, and these components of the AV 110 will operate in accordance with the instructions. In an example where the output of the control model indicates that a change of traveling speed of the AV 110 is required given a prediction of traffic condition, the control module 540 may instruct the motor of the AV 110 to change the traveling speed of the AV 110. In another example where the output of the control model indicates a need to detect characteristics of an object in the environment around the AV 110 (e.g., detect a speed limit), the control module 540 may instruct the sensor suite 140 to capture an image of the speed limit sign with sufficient resolution to read the speed limit and instruct the perception module 530 to identify the speed limit in the image.

### Example Route Preview Animation Generated Based on AV Sensor Data

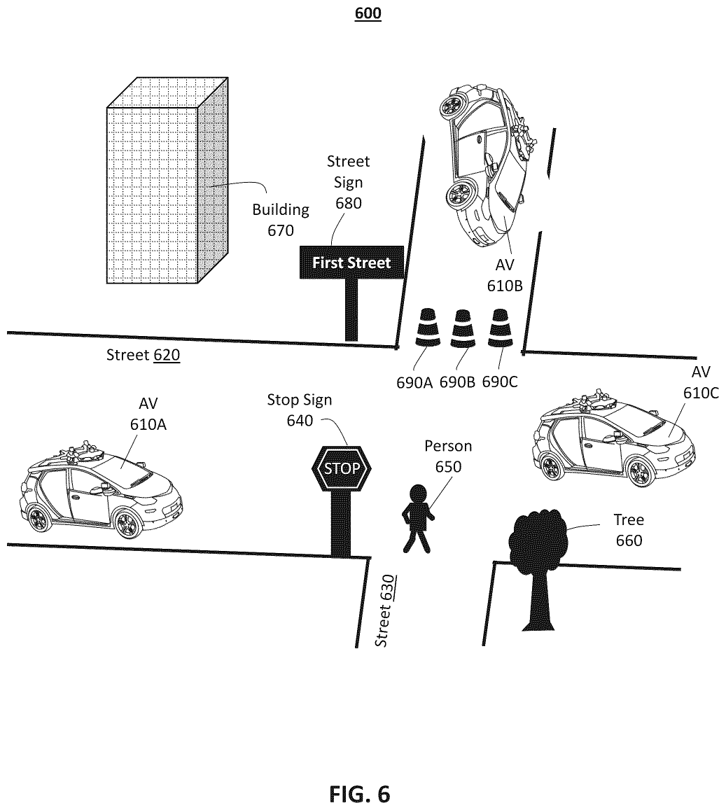

FIG. 6 illustrates an example environment 600 in which AVs 610A-610C operate and capture sensor data, according to some embodiments of the present disclosure. The AVs 610A-610C (collectively referred to as “AVs 610” or “AV 610”) may each be an embodiment of the AV 110 shown in FIG. 1. In the embodiments of FIG. 6, the AVs 610 operate, e.g., navigate, in the environment 600. The environment 600 is a real-world scene that includes various real-world objects. For purpose of illustrations, FIG. 6 shows streets 620 and 630, stop sign 640, person 650, tree 660, building 670, street sign 680, and construction cones 690A-690C (collectively referred to as “construction cones 690” or “construction cones 690”). In other embodiments, the environment 600 may include different, fewer, or more objects.

The AVs 610 include sensors (e.g., the sensor suite 140) that can detect the environment 600 and capture sensor data from the detection. For instance, the AVs 610 can capture images of the objects, point clouds of the objects, sound, or other types of sensor data in the environment 600. As the AVs 610 have different pose (position or orientation), they can capture different sensor data. For instance, the AV 610B can detect the construction cones 690, but the AV 610C cannot detect the construction cones 690. Also, even though the AVs 610A and 610B may both detect the building 670, they may capture images of the building 670 from different angles. Also, the AVs 610 may operate in the environment 600 at different times, and as different objects may present in the environment 600 at different times, the AVs 610 may detect different objects. For instance, the AV 610C may be on the street 630 at an earlier time, such as a time before the construction cones 690 were placed on the street 630, so the AV 610C did not detect the construction cones 690. In contrast, the AV 610B can detect the construction cones 690 as the AV 610B entered the street 620 at a later time, such as a time after the construction cones 690 were placed on the street 630.

The sensor data captured by the AVs 610 can be used to generate route preview animations, e.g., by the route preview module 230. The route preview module 230 may use the sensor data to determine a navigation route. For instance, based on sensor data from the AV 610B that captures the construction cones 690, the route preview module 230 may detect the road closure on the street 630 and determine a navigation route that avoids the street 630. In some embodiments, one or more of the AVs 610 may navigate in the environment 600 based on an instruction from the route preview module 230. For example, the route preview module 230 may instruct the AV 610A to navigate in the environment 600 and capture sensor data of the street 630 to determine whether the street 630 is still closed. As another example, the route preview module 230 may instruct an AV 610A to navigate in the environment 600 to capture sensor data needed by the route preview module 230 for generating an animation that previews a route including at least a portion of the environment 600.

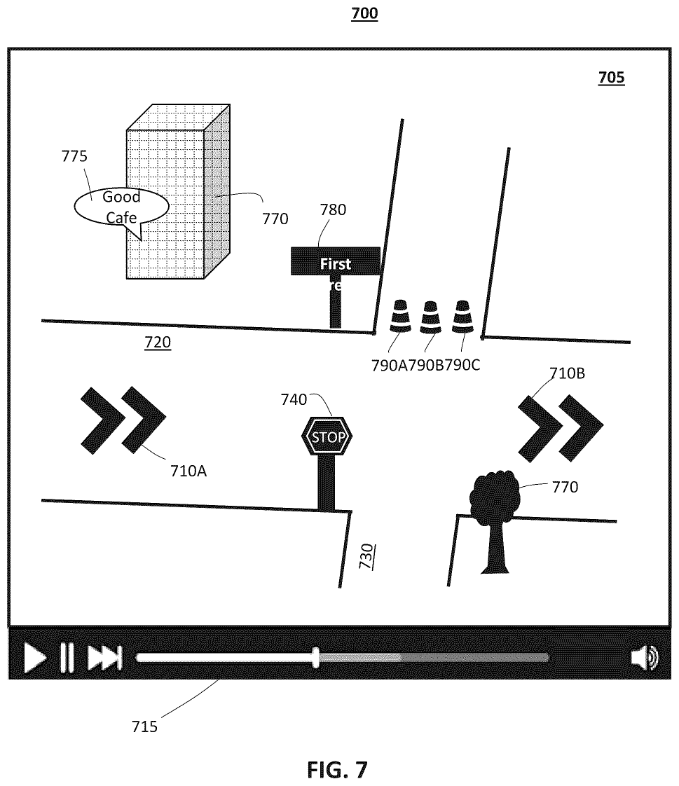

FIG. 7 illustrates an example user interface 700 presenting an animation that previews a route including the environment 600 in FIG. 6, according to some embodiments of the present disclosure. The animation may be generated by the route preview module 230, e.g., based on a request for animated route preview from a user. For the purpose of simplicity and illustration, FIG. 7 shows a frame 705 of the animation. The frame 705 includes graphical objects 720, 730, 740, 760, 770, 780, and 790A-790C that represent real-world objects in the environment 600. For instance, the graphical objects 720 and 730 represent streets 620 and 630, respectively. The graphical objects 740, 760, 770, 780, and 790A-790C represent the stop sign 640, person 650, tree 660, building 670, street sign 680, and construction cones 690.

The route preview module 230 can use sensor data captured by some or all of the AVs 610 to generate the animation. For instance, the route preview module 230 may generate the graphical objects 720, 730, 740, 760, 770, 780, and 790A-790C based on data generated by exterior sensors of the AVs 610. Taking the graphical object 770 for example, the route preview module 230 may use a point cloud generated by a LIDAR sensor to make a 3D model of the building 670. Further, the route preview module 230 can add images of the building 670 captured by exterior cameras of the AVs 610 to the 3D model to generate the graphical object 770. The route preview module 230 may determine not to show an object detected by the AVs 610 in the animation. In the embodiments of FIG. 7, the route preview module 230 determines not to show the person 650 in the animation, e.g., for the purpose of protecting the privacy of the person. In alternative embodiments, the route preview module 230 may generate an avatar representing the person 650 and include the avatar in the animation. The avatar may not include certain features of the person 650 so that the privacy of the person 650 can be protected.

In addition to the graphical objects 720, 730, 740, 760, 770, 780, and 790A-790C that represent real-world objects in the environment 600, the frame 705 also includes graphical objects 710A, 710B, and 775. The graphical objects 710A, 710B, and 775 are not representations of any real-world objects in the environment 600. Rather, the graphical objects 710A, 710B, and 775 may provide information associated with real-world objects in the environment 600. For instance, the graphical objects 710A and 710B show a direction of the navigation route along the street 620. The graphical object 710A or 710B may be interactive so that a user may interact with the graphical object 710A or 710B to change the animation. For instance, the user may click the graphical object 710A or 710B to increase the speed of moving along the street 620. Even though not shown in FIG. 7, the animation may also include other graphical objects that allow the user to change the navigation route, e.g., to change the moving direction and move to the graphical object 730 that represents the street 630. The graphical object 775 is a callout icon that provides information of the building 670 to the user. For the purpose of simplicity and illustration, the graphical object 775 in FIG. 7 displays a text string “Good Cafe” indicating that a good cafe is available in the building 670. In other embodiments, the graphical object 775 may provide other information. The information may be provided by a third party, e.g., a party that is associated with the cafe. The route preview module 230 may generate the graphical object 775 based on an interest of the user, a request of the third party, and so on.

In addition to facilitating user interaction through the graphical objects 710A, 710B, and 775, the user interface 700 also includes a control panel 705. The control panel 705 includes a plurality of elements through which users can control display of the animation. For instance, a user can use the panel 705 to select a frame of the animation by start or resume display of the animation, control volume of audio in the animation, control display speed, go to a particular frame of the animation, or perform other interactions with the animation. Even though not shown in FIG. 7, the user interface 700 can also allow users to submit new requests for animated route preview, modify an existing request for animated route preview, request ride services by AVs 110, and so on.

In some embodiments, a graphical object in the frame 705 may be generated based on one or more viewpoints, e.g., a viewpoint of a person or AV 110. For instance, the graphical object may be a graphical representation that appears as being perceived by the person or AV 110 from the viewpoint. The graphical object may be animated so that it changes as the viewpoint changes.

### Example Method of Providing Route Preview Animation

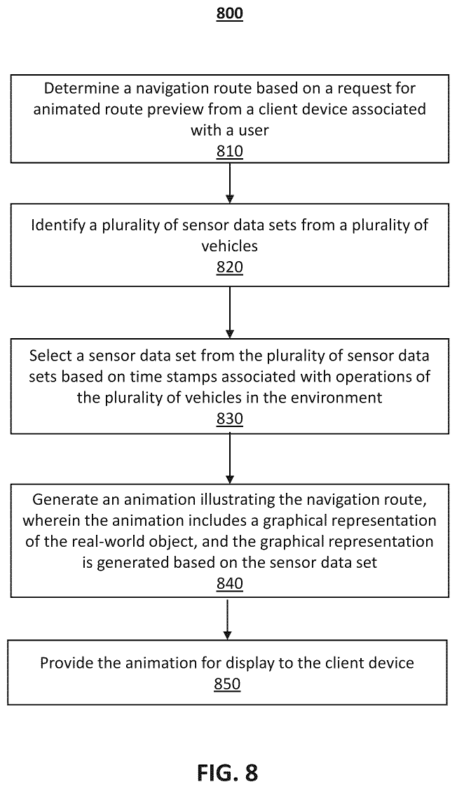

FIG. 8 is a flowchart showing a method 800 of providing a route preview animation, according to some embodiments of the present disclosure. The method 800 may be performed by the route preview module 230. Although the method 800 is described with reference to the flowchart illustrated in FIG. 8, many other methods of providing a route preview animation may alternatively be used. For example, the order of execution of the steps in FIG. 8 may be changed. As another example, some of the steps may be changed, eliminated, or combined.

The route preview module 230 determines, in 810, a navigation route based on a request for animated route preview from a client device associated with a user. The request may include information (e.g., requirements or preferences of the user) for a navigation route. For instance, the request may include one or more location parameters (e.g., location of a starting point, location of an intermediate stop along the navigation route, location of a final stop of the navigation route, and so on), one or more time parameters (e.g., a time window for the navigation, a particular date or time that the navigation starts or ends, etc.), one or more travel medium parameters (e.g., one or more types of travel medium), one or more distance parameters (e.g., a preference for a shorter or longer navigation distance, a maximum distance, a minimum distance, etc.), one or more entertainment parameters (e.g., preference for views along the navigation route, preference for activities that can be performed or avoided along the navigation route, etc.), and so on. The route preview module 230 may receive the request from a user interface running on the client device. The user interface may allow the user to provide the parameters.

In some embodiments, the route preview module 230 determines a plurality of candidate routes based on the request and selects the navigation route from the plurality of candidate routes. For instance, the route preview module 230 determines, based on sensor data from one or more vehicles (e.g., AVs 110) that operated along at least a portion of the candidate route, that a candidate route of the plurality of candidate routes has a condition that will interfere with a traffic flow along the candidate route. Then the route preview module 230 determines not to select the candidate route. In some embodiments, the request is received at a first time, the one or more vehicles operated along at least the portion of the candidate route at a second time, and a difference between the first time and the second time is less than a threshold duration of time. The threshold duration of time may be determined based on a classification of the condition, which may be determined by the route preview module 230 or the vehicle.

The route preview module 230 identifies, in 820, a plurality of sensor data sets from a plurality of vehicles. Each of the plurality of vehicles operated in an environment including at least a portion of the navigation route. Each plurality of sensor data sets captures at least a portion of a real-world object in the environment. In some embodiments, a sensor data set from a vehicle includes sensor data generated by one or more sensors (e.g., exterior sensors) of the vehicles. In some embodiments, the route preview module 230 may instruct a vehicle of the plurality of vehicles to operate in the environment and instruct one or more sensor of the vehicle to detect the real-world object.

The route preview module 230 selects, in 840, a sensor data set from the plurality of sensor data sets based on timestamps associated with operations of the plurality of vehicles in the environment. In some embodiments, the sensor data set is from a first vehicle of the plurality of vehicles. The route preview module 230 can select the sensor data set by determining that the first vehicle operated in the environment at a first time, that a second vehicle of the plurality of vehicles operated in the environment at a second time, that the first time is in a time window, and that the second time is not in a time window. The time window may indicate a recency of the sensor data. For instance, the time window may start from a time shortly before the time that the route preview module 230 selects the sensor data and ends at the time that the route preview module 230 selects the sensor data. The first time may be later than the second time.

The route preview module 230 generates, in 840, an animation illustrating the navigation route. The animation includes a graphical representation of a real-world object. The graphical representation is generated based on the sensor data set. The route preview module 230 may generate an audio for the real-world object based on a classification of the object and include the audio in the animation. In some embodiments, the route preview module 230 may receive an additional sensor data set capturing the real-world object from an additional vehicle that operated in the environment. The route preview module 230 may generate the graphical representation based on the sensor data set and the additional sensor data set.

The route preview module 230 provides, in 840, the animation for display to the client device. The route preview module 230 may provide a user interface associated with the animation, the user interface allowing the user to interact with the animation. The route preview module 230 may receive, through the user interface, an interaction of the user with the animation. The route preview module 230 can modify the animation based on the interaction of the user.

### Select Examples

Example 1 provides a method, including: determining a navigation route based on a request for animated route preview from a client device associated with a user; identifying a plurality of sensor data sets from a plurality of vehicles, wherein each of the plurality of vehicles operated in an environment including at least a portion of the navigation route, and each plurality of sensor data sets captures at least a portion of a real-world object in the environment; selecting a sensor data set from the plurality of sensor data sets based on timestamps associated with operations of the plurality of vehicles in the environment; generating an animation illustrating the navigation route, wherein the animation includes a graphical representation of the real-world object, and the graphical representation is generated based on the sensor data set; and providing the animation for display to the client device.

Example 2 provides the method of example 1, where the animation includes a graphical representation of an additional real-world object, and the graphical representation of the additional real-world object is generated based on an additional sensor data set.

Example 3 provides the method of example 2, where the sensor data set is from a first vehicle of the plurality of vehicles, and the additional sensor data set is from a second vehicle that is different from the first vehicle.

Example 4 provides the method of example 1, where the animation further includes a graphical object providing information associated with the real-world object.

Example 5 provides the method of example 1, further including: instructing a vehicle of the plurality of vehicles to operate in the environment surrounding the real-world object; and instructing one or more sensors of the vehicle to detect the real-world object.

Example 6 provides the method of example 1, where the sensor data set is from a first vehicle of the plurality of vehicles, and selecting the sensor data set includes: determining that the first vehicle operated in the environment at a first time; determining that a second vehicle of the plurality of vehicles operated in the environment at a second time; and determining that the first time is in a time window and that the second time is not in the time window.

Example 7 provides the method of example 1, further including: receiving an additional sensor data set capturing the real-world object from an additional vehicle that operated in the environment, and generating the graphical representation based on the sensor data set and the additional sensor data.

Example 8 provides the method of example 1, where generating the animation includes: generating an audio for the real-world object based on a classification of the real-world object; and including the audio in the animation.

Example 9 provides the method of example 1, where providing the animation for display to the client device includes: providing a user interface associated with the animation, the user interface allowing the user to interact with the animation.

Example 10 provides the method of example 9, further including: receiving, through the user interface, an interaction of the user with the animation; and modifying the animation based on the interaction of the user.

Example 11 provides one or more non-transitory computer-readable media storing instructions executable to perform operations, the operations including: determining a navigation route based on a request for animated route preview from a client device associated with a user; identifying a plurality of sensor data sets from a plurality of vehicles, wherein each of the plurality of vehicles operated in an environment including at least a portion of the navigation route, and each plurality of sensor data sets captures at least a portion of a real-world object in the environment; selecting a sensor data set from the plurality of sensor data sets based on timestamps associated with operations of the plurality of vehicles in the environment; generating an animation illustrating the navigation route, wherein the animation includes a graphical representation of the real-world object, and the graphical representation is generated based on the sensor data set; and providing the animation for display to the client device.

Example 12 provides the one or more non-transitory computer-readable media of example 11, where the animation includes a graphical representation of an additional real-world object, and the graphical representation of the additional real-world object is generated based on an additional sensor data set.

Example 13 provides the one or more non-transitory computer-readable media of example 12, where the sensor data set is from a first vehicle of the plurality of vehicles, and the additional sensor data set is from a second vehicle that is different from the first vehicle.

Example 14 provides the one or more non-transitory computer-readable media of example 11, where the animation further includes a graphical object providing information associated with the real-world object.

Example 15 provides the one or more non-transitory computer-readable media of example 11, where the sensor data set is from a first vehicle of the plurality of vehicles, and selecting the sensor data set includes: determining that the first vehicle operated in the environment at a first time; determining that a second vehicle of the plurality of vehicles operated in the environment at a second time; and determining that the first time is in a time window and that the second time is not in the time window.

Example 16 provides the one or more non-transitory computer-readable media of example 11, where the operations further include: receiving an additional sensor data set capturing the real-world object from an additional vehicle that operated in the environment, and generating the graphical representation based on the sensor data set and the additional sensor data.

Example 17 provides the one or more non-transitory computer-readable media of example 11, where generating the animation includes: generating an audio for the real-world object based on a classification of the object; and including the audio in the animation.

Example 18 provides a computer system, including: a computer processor for executing computer program instructions; and one or more non-transitory computer-readable media storing computer program instructions executable by the computer processor to perform operations including: determining a navigation route based on a request for animated route preview from a client device associated with a user; identifying a plurality of sensor data sets from a plurality of vehicles, wherein each of the plurality of vehicles operated in an environment including at least a portion of the navigation route, and each plurality of sensor data sets captures at least a portion of a real-world object in the environment, selecting a sensor data set from the plurality of sensor data sets based on timestamps associated with operations of the plurality of vehicles in the environment, generating an animation illustrating the navigation route, wherein the animation includes a graphical representation of the real-world object, and the graphical representation is generated based on the sensor data set, and providing the animation for display to the client device.

Example 19 provides the computer system of example 18, where the operations further include: instructing a vehicle of the plurality of vehicles to operate in the environment surrounding the real-world object; and instructing one or more sensors of the vehicle to detect the real-world object.

Example 20 provides the computer system of example 18, where the sensor data set is from a first vehicle of the plurality of vehicles, and selecting the sensor data set includes: determining that the first vehicle operated in the environment at a first time; determining that a second vehicle of the plurality of vehicles operated in the environment at a second time; and determining that the first time is in a time window and that the second time is not in the time window.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
determining a navigation route based on a request for animated route preview from a client device associated with a user;
identifying a plurality of sensor data sets from a plurality of vehicles, wherein each of the plurality of vehicles operated in an environment including at least a portion of the navigation route, and each of the plurality of sensor data sets captures at least a portion of a real-world object in the environment;
selecting a sensor data set from the plurality of sensor data sets based on timestamps associated with operations of the plurality of vehicles in the environment;
generating an animation illustrating the navigation route, wherein the animation includes a graphical representation of the real-world object, and the graphical representation is generated based on the sensor data set; and
providing the animation for display to the client device.

2. The method of claim 1, wherein the animation further includes a graphical representation of an additional real-world object, and the graphical representation of the additional real-world object is generated based on an additional sensor data set.

3. The method of claim 1, wherein the sensor data set is from a first vehicle of the plurality of vehicles, and the additional sensor data set is from a second vehicle that is different from the first vehicle.

4. The method of claim 1, wherein the animation further includes a graphical object providing information associated with the real-world object.

5. The method of claim 1, further comprising:
instructing a vehicle of the plurality of vehicles to operate in the environment surrounding the real-world object; and
instructing one or more sensors of the vehicle to detect the real-world object.

6. The method of claim 1, wherein the sensor data set is from a first vehicle of the plurality of vehicles, and selecting the sensor data set comprises:
determining that the first vehicle operated in the environment at a first time;
determining that a second vehicle of the plurality of vehicles operated in the environment at a second time; and
determining that the first time is in a time window and that the second time is not in the time window.

7. The method of claim 1, further comprising:
receiving an additional sensor data set capturing the real-world object from an additional vehicle that operated in the environment, and
generating the graphical representation based on the sensor data set and the additional sensor data.

8. The method of claim 1, wherein generating the animation comprises:
generating an audio for the real-world object based on a classification of the real-world object; and
including the audio in the animation.

9. The method of claim 1, wherein providing the animation for display to the client device comprises:
providing a user interface associated with the animation, the user interface allowing the user to interact with the animation.

10. The method of claim 9, further comprising:
receiving, through the user interface, an interaction of the user with the animation; and
modifying the animation based on the interaction of the user.

11. One or more non-transitory computer-readable media storing instructions executable to perform operations, the operations comprising:
determining a navigation route based on a request for animated route preview from a client device associated with a user;
identifying a plurality of sensor data sets from a plurality of vehicles, wherein each of the plurality of vehicles operated in an environment including at least a portion of the navigation route, and each plurality of sensor data sets captures at least a portion of a real-world object in the environment;
selecting a sensor data set from the plurality of sensor data sets based on timestamps associated with operations of the plurality of vehicles in the environment;
generating an animation illustrating the navigation route, wherein the animation includes a graphical representation of the real-world object, and the graphical representation is generated based on the sensor data set; and
providing the animation for display to the client device.

12. The one or more non-transitory computer-readable media of claim 11, wherein the animation includes a graphical representation of an additional real-world object, and the graphical representation of the additional real-world object is generated based on an additional sensor data set.

13. The one or more non-transitory computer-readable media of claim 12, wherein the sensor data set is from a first vehicle of the plurality of vehicles, and the additional sensor data set is from a second vehicle that is different from the first vehicle.

14. The one or more non-transitory computer-readable media of claim 11, wherein the animation further includes a graphical object providing information associated with the real-world object.

15. The one or more non-transitory computer-readable media of claim 11, wherein the sensor data set is from a first vehicle of the plurality of vehicles, and selecting the sensor data set comprises:
determining that the first vehicle operated in the environment at a first time;
determining that a second vehicle of the plurality of vehicles operated in the environment at a second time; and
determining that the first time is in a time window and that the second time is not in the time window.

16. The one or more non-transitory computer-readable media of claim 11, wherein the operations further comprise:
receiving an additional sensor data set capturing the real-world object from an additional vehicle that operated in the environment, and
generating the graphical representation based on the sensor data set and the additional sensor data.

17. The one or more non-transitory computer-readable media of claim 11, wherein generating the animation comprises:
generating an audio for the real-world object based on a classification of the real-world object; and
including the audio in the animation.

18. A computer system, comprising:
a computer processor for executing computer program instructions; and
one or more non-transitory computer-readable media storing computer program instructions executable by the computer processor to perform operations comprising:
determining a navigation route based on a request for animated route preview from a client device associated with a user;
identifying a plurality of sensor data sets from a plurality of vehicles, wherein each of the plurality of vehicles operated in an environment including at least a portion of the navigation route, and each plurality of sensor data sets captures at least a portion of a real-world object in the environment;
selecting a sensor data set from the plurality of sensor data sets based on timestamps associated with operations of the plurality of vehicles in the environment;
generating an animation illustrating the navigation route, wherein the animation includes a graphical representation of the real-world object, and the graphical representation is generated based on the sensor data set; and
providing the animation for display to the client device.

19. The computer system of claim 18, wherein the operations further comprise:
instructing a vehicle of the plurality of vehicles to operate in the environment surrounding the real-world object; and
instructing one or more sensors of the vehicle to detect the real-world object.

20. The computer system of claim 18, wherein the sensor data set is from a first vehicle of the plurality of vehicles, and selecting the sensor data set comprises:
determining that the first vehicle operated in the environment at a first time;
determining that a second vehicle of the plurality of vehicles operated in the environment at a second time; and
determining that the first time is in a time window and that the second time is not in the time window.
